(19) United States
(12) Patent Application Publication
(10) Pub. No.: US 2006/0064209 A1
(43) Pub. Date: Mar. 23, 2006

(54) Car display device for use in control of playback device

(76) Inventor: Kyung-Soo Park, Gwangmyeong-Si (KR)

Correspondence Address: HARNESS, DICKEY & PIERCE, P.L.C., P.O. BOX 828, BLOOMFIELD HILLS, MI, 48303, US

(21) Appl. No.: 10/999,862

(22) Filed: Nov. 30, 2004

(30) Foreign Application Priority Data
Sep. 20, 2004 (KR) 2004-74997

(51) Int. Cl. G06F 17/00

(52) U.S. Cl. 701/2; 701/1

(57) ABSTRACT

The present invention relates to a car display device for use in the control of a playback device. The car display device, which is controlled by a remote controller, provided with an input unit, an output unit and operation buttons, and connected to one or more playback devices to control the playback devices, includes a remote controller information Data Base (DB), a remote control signal-receiving unit, a control unit and a remote control signal-transmitting unit. According to the present invention, the playback and display devices are integrally controlled using a single remote controller, thus removing a danger factor in driving, and reducing inconvenience and expenses caused by purchasing separate remote controllers.

### BACKGROUND OF THE INVENTION

1. Field of the Invention

The present invention relates generally to a car display device for use in the control of a playback device and, more particularly, to a car display device for use in the control of a playback device, which enables a user to integrally control the display device itself and the playback device mounted in a vehicle using a single remote controller.

2. Description of the Related Art

With the development of video display devices and communication technology, there are many cases where audio and video players and navigational equipment are mounted inside vehicles and various types of multimedia contents are displayed in the vehicles.

Generally, multimedia playback devices used in vehicles include televisions, video and Digital Versatile Disk (DVD) players, and navigational equipment.

To use such playback devices, a display device, which is mounted on the dashboard, headrest or ceiling of a vehicle to output video and audio, is required. Furthermore, a remote controller using infrared transmission is usually provided to the display device to allow a driver or back-seated passenger to manipulate the playback devices.

Such a conventional playback device using a remote controller is shown in FIGS. 1 and 2. FIG. 1 is a view showing the mounting position of conventional playback and display devices. FIG. 2 is a view showing the connection configuration of the conventional playback and display devices.

The conventional car playback and display devices are described with reference to FIGS. 1 and 2 below. The display device 100 and the playback device 200 are mounted inside a vehicle 10.

A Liquid Crystal Display (LCD) is generally used as the display device 100, but a Plasma Display Panel (PDP) may be used as the display device 100.

The display device 100 includes an output unit 110, an input unit 120, operation buttons 130 and a remote control signal-receiving unit 140. A separate remote controller 150 is used to control the display device 100.

The output unit 110 and the input unit 120 are used to output and receive video and audio signals, respectively. The output unit 110 outputs video and audio input from the playback device 200. The input unit 120 is provided with an element capable of receiving the video and audio signals from the playback device 200, and a detailed description of such devices is omitted because the devices are commonly used.

The operation buttons 130 are generally placed on the front of the display device 100, and preferably include buttons for controlling the power, colors and brightness of the display device 100.

The remote control signal-receiving unit 140 converts an infrared signal, received from the remote controller 150, into a control signal so that a driver or passenger can control the display device 100 at a long distance.

The playback device 200 includes control buttons 210, an output unit 220, an output cable 230, a remote control signal-input unit 240, a remote control signal cable 250, and a remote control signal-receiving unit 260. Like the display device 100, a separate remote controller 270 is used to control the playback device 200.

The playback device 200 transmits broadcast TV video, Video Tape Recorder (VTR) output video and DVD output video to the display device 100 through the output cable 230 so that the video is output through the display device 100.

The remote control signal-receiving unit 260 connected to the remote control signal-input unit 240 through the remote control signal cable 250 is used to control the playback device 200 using the remote controller 270. However, most car playback devices are mounted in dashboards in the fronts of vehicles. Accordingly, when the driver or passenger manipulates the playback device 200 using the remote controller 270, a gear shift lever or console box may be an obstacle, so that the remote control signal-receiving unit 260 is extended to be mounted on the upper end of a front panel or a ceiling.

However, if separate remote controllers 150 and 270 are used to control the display device 100 and the playback device 200, respectively, the inconvenience of use occurs in the light of the characteristics of the vehicle.

That is, a driver must manipulate separate remote controllers while driving to control the playback device 200 and the display device 100, thus preventing the driver from driving safely.

Furthermore, since there are many cases where a display device and a playback device manufactured by different companies are used, separate remote controllers for the display device 100 and the playback device 200 must be purchased if an integrated remote control code is not stored in the display device 100 and the playback device 200, thus causing the inconvenience of use and unnecessary expenses.

### SUMMARY OF THE INVENTION

Accordingly, the present invention has been made keeping in mind the above problems occurring in the prior art, and an object of the present invention is to provide a car display device for use in the control of a playback device, which enables a user to integrally control the display device itself and the playback device using a single remote controller.

Another object of the present invention is to provide a car display device for use in the control of a playback device, which can control the playback device by transmitting a control signal to the remote control signal-receiving unit of the playback device through the remote control signal-transmitting unit of the display device.

Another object of the present invention is to provide a car display device for use in the control of a playback device, which allows a user to manually input and store the functions of the buttons of a remote controller in the case where a new playback device is connected thereto, thus allowing the user to set the remote controller or change the setting of the remote controller according to user convenience.

In order to accomplish the above object, the present invention provides a car display device, the car display device being controlled by a remote controller, having an input unit, an output unit and operation buttons, and being connected to one or more playback devices to control the playback devices, including a remote controller information Data Base (DB) for classifying information on the remote control codes of a plurality of playback devices, which are manufactured by one or more manufacturing companies, according to the manufacturing companies, and storing the classified information; a remote control signal-receiving unit for converting an infrared signal, which is wirelessly input from the remote controller, into a control signal; a control unit for calling information on the manufacturing company of a playback device and calling the remote control code of the manufacturing company of the playback device when the control signal is input from the remote control signal-receiving unit; and a remote control signal-transmitting unit for transmitting the control code of the remote control code, which is identical to the command of the control signal, to the playback device.

The input unit may include a video input unit and an audio input unit, and the output unit may include a video output unit and an audio output unit.

The control unit may display a list of the commands of the remote control code through the output unit, and allow a signal, which selects a specific control code from the list, to correspond the command of the specific control code when the selection signal is input from the remote controller.

The remote controller information DB may allow the selection signal, which is input from the remote controller, to correspond to the specific control code and be stored.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the mounting position of conventional playback and display devices;

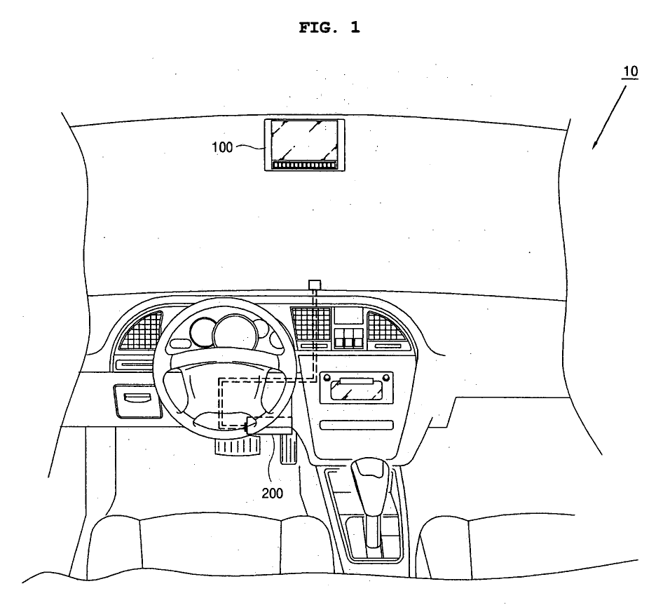

FIG. 2 is a view showing the connection configuration of the conventional playback and display devices;

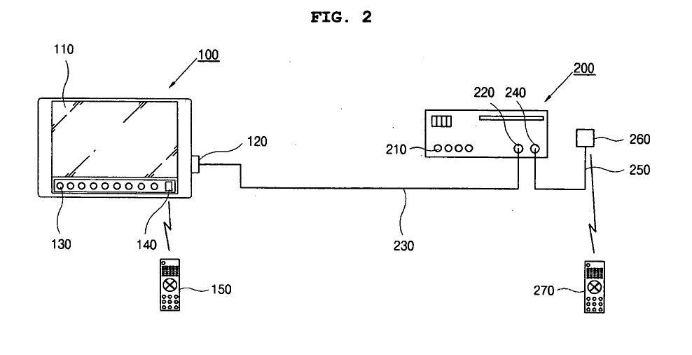

FIG. 3 is a view showing the connection configuration of playback and display devices according to an embodiment of the present invention; and

FIG. 4 is a view showing the construction of the display device.

### DESCRIPTION OF THE PREFERRED EMBODIMENTS

Reference now should be made to the drawings, in which the same reference numerals are used throughout the different drawings to designate the same or similar components.

### First Embodiment

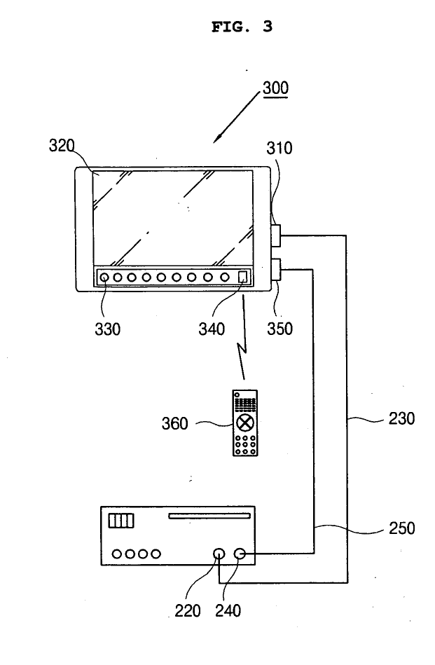

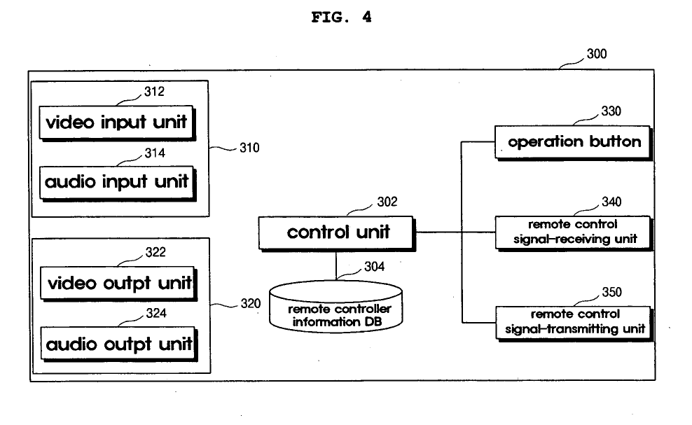

FIG. 3 is a view showing the connection configuration of playback and display devices according to a first embodiment of the present invention. FIG. 4 is a view showing the construction of the display device.

The construction of the playback and display devices is described with reference to FIGS. 3 and 4.

The display device 300 according to the first embodiment of the present invention includes an input unit 310, an output unit 320, operation buttons 330, a remote control signal-receiving unit 340 and a remote control signal-transmitting unit 350. A separate remote controller 360 is used to control the display device 300.

An output cable 230 connected to the output unit 220 of the playback device 200 is connected to the input unit 310 of the display device 300, and a remote control signal cable 250 connected to the remote control signal-transmitting unit 350 of the display device 300 is connected to the remote control signal-input unit 240 of the playback device 200.

As shown in FIG. 4, the input unit 310 of the display device 300 includes a video input unit 312 and an audio input unit 314, and the output unit 320 of the display device 300 includes a video output unit 322 and an audio output unit 324.

Furthermore, the display device 300 includes a control unit 302 and a remote controller information DB 304.

When a video signal and a audio signal transmitted from the playback device 200 are input to the display device 300 through the input unit 310, the control unit 302 transmits the video signal and the audio signal to the video output unit 322 and the audio output unit 324, respectively. A common video display device, such as a Cathode Ray Tube (CRT), an LCD or a PDP, can be used as the video output unit 322. A common audio output device, such as a speaker, can be used as the audio output unit 324. It is preferable to use a speaker mounted in the vehicle 10 rather than providing a separate speaker to the display device 300.

The control unit 302 controls the components of the display device 300, and outputs the video and audio signals after conversion. Furthermore, the control unit 302 sets data for setting the buttons of the remote controller 360.

The remote controller information DB 304 classifies information on the remote control codes of a plurality of playback devices manufactured by one or more manufacturing companies according to the manufacturing companies, and stores the classified information. That is, a single manufacturing company markets various types of playback devices, and a unique remote control code set on the playback devices is stored in the remote controller information DB 304. Generally, since playback devices manufactured by the manufacturing company have the same remote control code even though they are different models, most playback devices manufactured by one manufacturing company can be controlled using a single remote controller if the remote control code of the manufacturing company is stored.

The operation buttons 330 are used to control various operations of the display device 300 and provided to perform screen control functions, such as power and color and brightness adjustment, and a volume control function may be selectively added. Furthermore, it is possible to add playback, rewind and temporary stop functions that are used to control the operation of the playback device 200.

An independent infrared light-receiving method is applied to the remote control signal-receiving unit 340, and the remote control signal-receiving unit 340 converts an infrared signal, which is wirelessly input from the remote controller 360, into a control signal.

The remote control signal-transmitting unit 350 transmits the control code of a remote control code, which is identical to the command of the control signal, to the playback device 200. That is, when the infrared signal is input from the remote controller 360, the remote control signal-receiving unit 340 converts the infrared signal into the control signal, and the control unit 302 detects the manufacturing company of a playback device 200 currently connected to the display device 300. Furthermore, the control unit 302 calls the remote control code of the manufacturing company of the playback device 200, and transmits the control code of the remote control code, which corresponds to a command input from the remote controller 360, to the remote control signal-input unit 240 of the playback device 200.

In other words, according to a prior art, the playback device 200 is controlled in such a way that the infrared signal is input to the remote control signal-receiving unit 260 connected to the playback device 200. However, according to the present invention, the playback device 200 can be controlled using only the remote controller for display 360 because the remote control signal-receiving unit 260 is provided in the display device 300.

Accordingly, when a driver presses the power button of the remote controller 360, the power of the playback device 200 and the display device 300 is turned on at the same time, and a VTR or DVD is played when the driver presses a playback button that corresponds only to the playback device 200. Such a control scheme corresponds to the case of a plurality of playback devices 200 as well as the case of a single playback device 200. That is, in the case where external playback devices, such as a DVD player and navigational equipment, are connected to a single display device 300, all the external playback devices can be controlled using a single remote controller 360 if the remote control code of the DVD player and navigational equipment is stored and the remote control signal-transmitting unit 350 has a plurality of ports.

### Second Embodiment

As described above, since various types of remote control codes are previously stored in the display device 300, a playback device 200 can be controlled by calling a corresponding remote control code if information on the manufacturing company of the playback device 200 is detected. However, in consideration of an industrial situation in which a plurality of new products is marketed within a short period, the display device 300 may not store the remote control codes of all manufacturing companies.

In this case, a user needs to manually set a remote control code or control buttons.

For this purpose, the control unit 302 displays a list of control commands, which are input from the remote controller 360, on the output unit 320 so that the user can set the remote controller 360 according to the items of the list. That is, when a list of various commands is displayed on the video output unit 322 and the user presses a specific button, a command corresponding to the specific button is set.

For example, when a user selects playback from a command list displayed on the video output unit 322, presses a specific button A of the remote controller 360 and presses a command set button or memory button, the display device 300 detects that the button A is a playback button, and allows the control code of the button A to correspond to a playback function and be stored in the remote controller information DB 304. Accordingly, if the user presses the button A thereafter, the display device 300 detects that the playback function has been selected, so that the display device 300 calls a control code corresponding to the playback function and operates the playback device 200.

Furthermore, when the user selects volume-up from the command list and presses a specific button B of the remote controller 360, the display device 300 detects that the button B is a volume-up button and turns up the volume.

Through such a control method, the operation buttons of the playback device 200 or display device 300 can be newly set according to user convenience.

According to the present invention, the playback and display devices are integrally controlled using a single remote controller, thus removing a danger factor in driving, and reducing inconvenience and expenses caused by purchasing separate remote controllers.

Furthermore, according to the present invention, the buttons of a remote controller can be set according to the selection of a user in the case of using the remote controller to control a playback device, the remote control code of which is not stored in the display device, thus maximizing user convenience.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A car display device, the car display device being controlled by a remote controller, having an input unit, an output unit and operation buttons, and being connected to one or more playback devices to control the playback devices, comprising:
a remote controller information Data Base (DB) for classifying information on remote control codes of a plurality of playback devices, which are manufactured by one or more manufacturing companies, according to the manufacturing companies, and storing the classified information;
a remote control signal-receiving unit for converting an infrared signal, which is wirelessly input from the remote controller, into a control signal;
a control unit for calling information on a manufacturing company of a playback device and calling a remote control code of the manufacturing company of the playback device when the control signal is input from the remote control signal-receiving unit; and
a remote control signal-transmitting unit for transmitting a control code of the remote control code, which is identical to a command of the control signal, to the playback device.

2. The car display device as set forth in claim 1, wherein:
the input unit comprises a video input unit and an audio input unit; and
the output unit comprises a video output unit and an audio output unit.

3. The car display device as set forth in claim 1 or 2, wherein the control unit displays a list of commands of the remote control code through the output unit, and allows a signal, which selects a specific control code from the list, to correspond a command of the specific control code when the selection signal is input from the remote controller.

4. The car display device as set forth in claim 3, wherein the remote controller information DB allows the selection signal, which is input from the remote controller, to correspond to the specific control code and be stored.
